(19) United States
(12) Patent Application Publication
(10) Pub. No.: US 2022/0236944 A1
(43) Pub. Date: Jul. 28, 2022

(54) AUDIO VIDEO INTERCOM DEVICE, SYSTEM, AND METHODS

(71) Applicant: Astrohaus Inc., New York, NY (US)

(72) Inventor: Adam Leeb, New York, NY (US)

(73) Assignee: Astrohaus Inc., New York, NY (US)

(21) Appl. No.: 17/587,258

(22) Filed: Jan. 28, 2022

Related U.S. Application Data
(60) Provisional application No. 63/142,682, filed on Jan. 28, 2021.

(51) Int. Cl. G06F 3/16; H04R 1/02; H04R 1/08; G06F 3/041; H04N 5/232; H04R 3/00; G06F 3/02

(52) U.S. Cl. CPC G06F 3/165; H04R 1/028; H04R 1/08; G06F 3/041; H04L 65/403; H04R 3/00; G06F 3/02; H04R 2499/15; H04R 2430/01; H04N 5/232

(57) ABSTRACT

Audio video intercommunication devices, systems, and methods are disclosed that can include one-on-one communication or group communication using an activation button. They are designed for small groups of people who need to interact on a relatively frequent basis—for example, people working on a work project. The disclosed system can be limited to a few users and allow for informal, instantaneous communication between some or all of the members of the system.

### FIELD

This disclosure relates to communication devices, systems, and methods, and more particularly to audio-video intercom devices, systems, and methods that include instant face-to-face video and audio connections and to a system that includes such devices.

### BACKGROUND

There are a multitude of systems and devices that are known for communication between people in work or casual settings. For example, communication devices such as desktop or laptop computers, smart displays, smart tablets, smartphones, and a variety of other devices can be used for communication between two or more entities. Included in the systems that enable communication between two or more entities are applications that are specifically devoted to these interactions. Such applications include, for example, SKYPE, GOOGLE MEET, FACEBOOK MESSENGER, SLACK, ZOOM, CISCO WEBEX, and various sorts of electronic mail programs (e-mail), to name a few.

Many of these communication systems require devices that are networked with server systems that handle all connection and access features. Requiring connections that may be either through a wireless local area network (WLAN) or through a local area network (LAN). These devices can require connections to servers on the internet or locally. Accessing these servers can require that the user first be logged onto the network before using them. In addition, they can require configuration with the server or other steps to set up their operation. These additional steps in setting up the devices add complexity to inter-office communications and take away precious time from productivity.

### SUMMARY

One thing that is missing from existing systems for communication between users is a device that is devoted to instant and high-fidelity audio and video interactions that require no call setup or dialing. Existing systems excel for simple audio, planned meetings, and asynchronous text communication. Missing is the ability to have frictionless, rich communication in real-time with colleagues and collaborators without any setup, dialing, or ringing. This prevents informal communication, building of camaraderie, and fast collaboration. There is a need for a simple, all-in-one device devoted to instant audio/video communication. There is a need for a video intercommunication system that can open a communication session with high-quality video and audio between two or more participants with a single button press. Such a device could be used for informal or casual communications between colleagues, friends, or family.

In one aspect, an audio-video intercom device is disclosed that includes a console having an embedded computer, an electronic display attached to and in electronic communication with the console. The disclosed device can further include at least one camera in electronic communication with the console. In some embodiments, the at least one camera can be physically attached to the console. The console can also include one or more control buttons, including a one-click activation button that is structured and configured to broadcast at least an audio-video signal to another user. The console can also include a volume control knob and one or a plurality of preset programming buttons. In some embodiments, the control buttons can include buttons that may be preset programming buttons. In some embodiments, the console can also include at least one microphone and at least one speaker. In some embodiments, the electronic display can include a touchscreen.

Further embodiments may include an electronic display with measurements of about five inches to about twenty inches on the diagonal. In other embodiments, the control buttons can include a focus mode button to prevent unwanted calls. In some embodiments with a focus button activated, a caller can record a message for later viewing.

In another aspect, a system of audio-video intercom devices is disclosed. The system can include two or more audio-video intercom devices. The audio-video intercom devices can include a console having an embedded computer, an electronic display attached to and in electronic communication with the console and at least one camera, at least one microphone, and at least one speaker in electronic communication with the console. The console can include one or more control buttons, including a one-click activation button. The one-click activation button can be structured and configured for the conduction of two-way audio-video communication with another party. In some embodiments, the electronic display can include a touchscreen. In some embodiments, a volume control knob can be one of the buttons. In other embodiments, there can be at least one preset programming button or a plurality of preset programming buttons. In other embodiments, the control buttons can include a focus mode button to prevent unwanted calls. In some embodiments with a focus button activated, a caller can record a message for later viewing.

In yet another aspect, a method of communicating using an audio-video intercom device is disclosed that includes providing an audio-video intercom device and communicating with another user. Wherein the method comprises the steps of providing an audio-video intercom device comprising a counsel having an embedded computer, with an electronic display attached to and in communication with the console. The console having further at least one camera, at least one microphone, and at least one speaker attached to and in electronic communication with the console. The console has at least one or more control buttons where one of the control buttons is an activation button which can allow a user to broadcast an audio signal and begin a two-way communication with another user having the audio-video intercom device. In some embodiments, the electronic display can include a touchscreen. In some embodiments, the one or more controls buttons can include a volume-control knob. In further embodiments, the one or more controls buttons can have one or more preset programming buttons. Further, in some embodiments, one of the control buttons can be a focus mode button, which, when activated by depressing, can activate a focus mode that blocks incoming communications.

The above summary is not intended to describe each disclosed embodiment of every implementation of the present disclosure. The brief description of the drawings and the detailed description which follow more particularly exemplifies illustrative embodiments.

### BRIEF DESCRIPTION OF THE DRAWINGS

FIG. 1 is a front view of an embodiment of a disclosed audio-video intercom device.

FIG. 2 is a rear view of an embodiment of a disclosed audio-video intercom device.

FIG. 3 is a top view of an embodiment of a disclosed audio-video intercom device.

FIG. 4 is a left-side view of an embodiment of a disclosed audio-video intercom device.

FIG. 5 is a right-side view of an embodiment of a disclosed audio-video intercom device.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present disclosure. The following detailed description, therefore, is not to be taken in a limiting sense.

In response to the needs expressed above, an audio-video intercom device and system are disclosed herein that meet some of these needs. The disclosed device can provide instant face-to-face video and audio connections for one-on-one or team collaboration. It is contemplated that the disclosed audio-video intercom device can be connected to an internet-connected network directly (using wired or wireless connections) in a workplace or a home environment.

The disclosed audio-video intercom devices, systems, and methods can include one-on-one or group communication. The disclosed device, systems, and method are designed for individuals and small groups of people who need to interact on a relatively frequent basis—for example, a CEO and CFO or a multi-disciplinary team working on a project. As an example, a project coordinator can be working with concept prototypers, marketing specialists, and production engineers on a project, such as making the disclosed device. They may be located in different office cubicles, in different buildings, in different physical locations—either close to the project coordinator or distant from the project coordinator, such as at home, in an engineering facility, or at a manufacturing location. The disclosed intercom device can facilitate collaborative conversations between such people using video and audio without necessitating pre-scheduled meetings. Such conversations can be formal or informal.

The purpose of the disclosed audio-video intercom device and systems is to provide interactive camaraderie (the old cliché “water cooler” interactions) where ideas can be created and expanded upon in an informal manner. The disclosed system can allow for instantaneous communication with one or many other participants in the system. It is contemplated, although not required, that the disclosed system of audio-video intercom devices can be used for a small group of people working on one or more projects.

The disclosed system of limited, interconnected audio-video intercom devices is meant to be primarily utilized as a team communication business tool for fast, informal communications. However, any other conceivable uses are also within the scope of this disclosure. One of the unique features of the disclosed system is that it can provide “one-click” conversation channels for audio and video communications. The contemplated system can be configured in several ways. For example, it can be configured to allow a user only to access another particular device on the limited system network. It can allow for conference team meetings. It can be used by a user to quickly query another user on the system for a detail they need to perform the job. In general, all of the disclosed audio-video intercom devices that can constitute a system are, typically, always in the “on” or “active” mode. In addition, the contemplated system can be “private” in the sense that only users that belong to a limited access system can communicate with each other.

The disclosed system can include a number of disclosed audio-video intercom devices that are interconnected. The disclosed system does not necessarily require a server—only a communication connection with all of the intercom devices in the system. This can be achieved in any conceivable way. For example, a limited number of devices can be hard-wired to each other, in which case the system resembles a multi-user video telephone system. In other examples, the limited number of devices can be interconnected wirelessly through a local hub, a LAN system, or even on a particular web address on the interne.

The disclosed device can include an electronic display. The display can be a liquid crystal (LC) display or a light-emitting diode (LED) display device. In some embodiments, the display can be a touchscreen to provide additional interaction options for the disclosed device. The disclosed device can also include an embedded computing device, at least one speaker, at least one microphone, a volume knob, soft keys, and a dedicated activation button. The soft keys can be optional and can be configured in the software of the embedded computer for various purposes, such as to connect the disclosed device to one or more other such devices. The activation button can allow the user to broadcast at least an audio signal (and possibly a video signal) when depressed so that other units selected by the soft keys can receive the signal from the user. In some embodiments, the activation button can be a one-click button that can be held down for the duration of the activation. In other embodiments, the activation button can be activated when depressed one time and then deactivated when pressed a second time. Any other configurations which allow selective broadcasting from the user's console can also be within the scope of this disclosure.

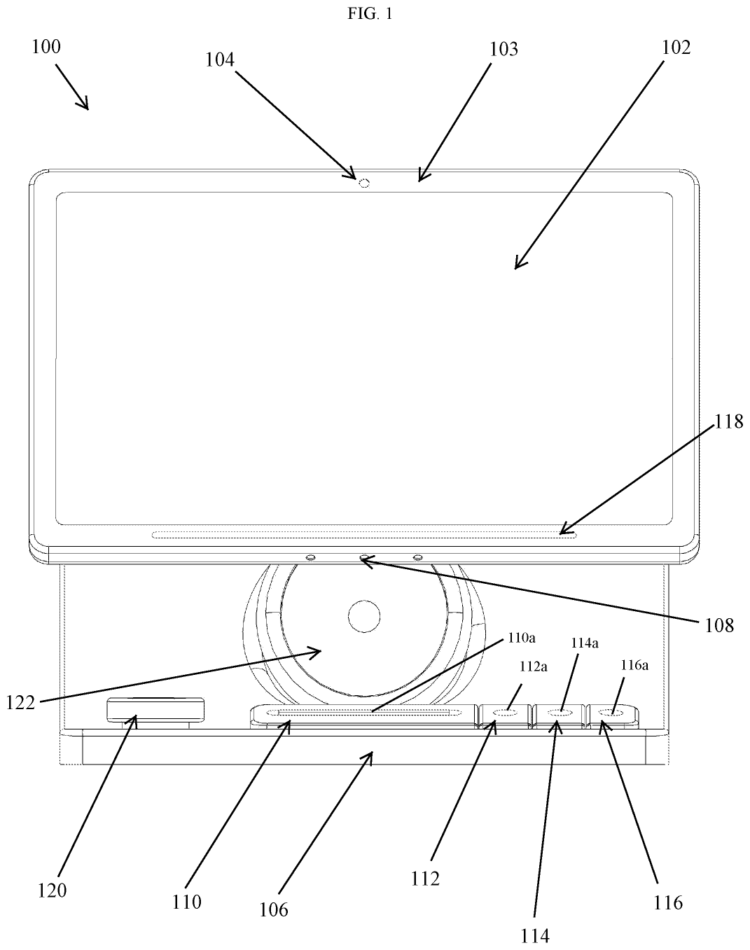

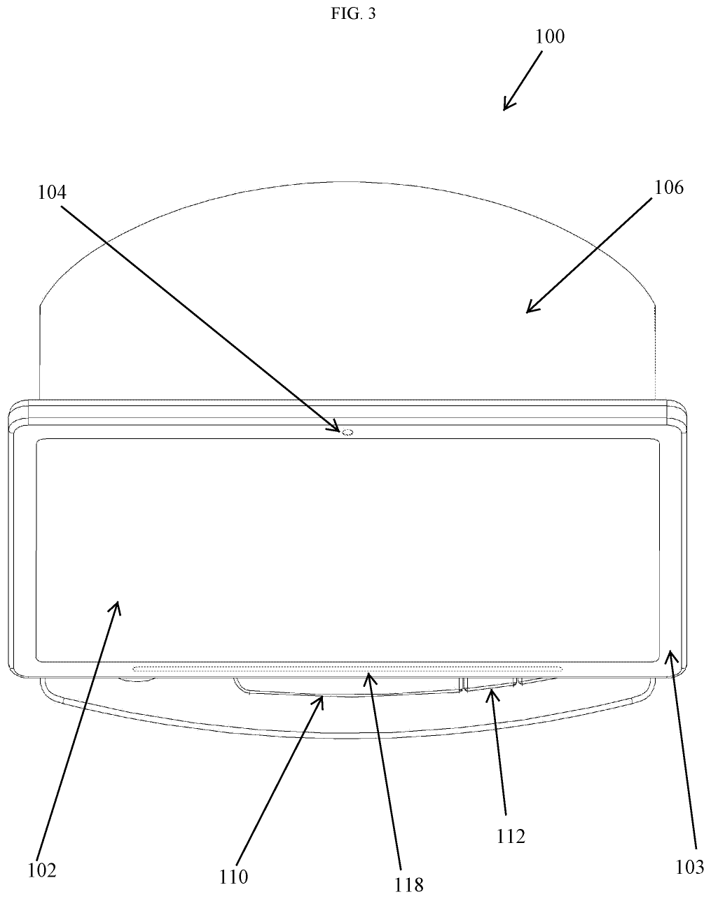

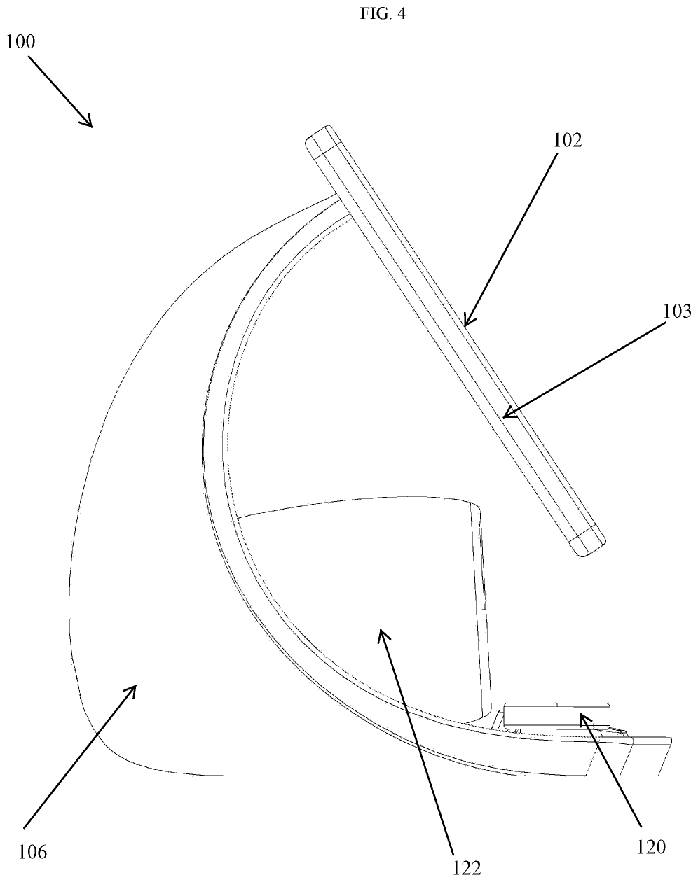

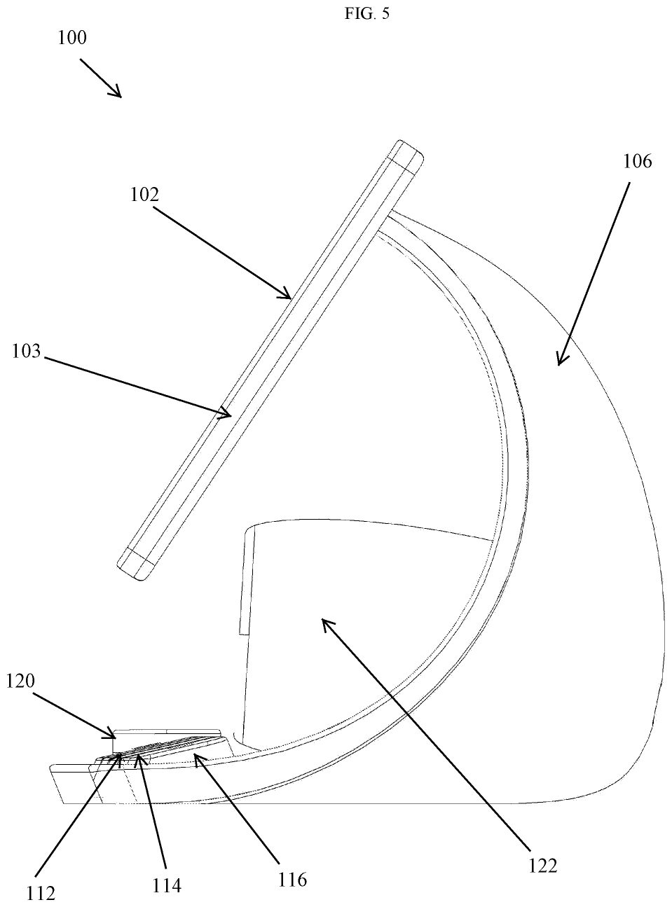

The electronic display can be touch-sensitive or not and can be from about 5 inches diagonal to about 20 inches diagonal or even larger. However, it is envisioned that for desktop use in an office-like setting, the device might have a typical dimension of about 7 inches in diagonal. Additionally, the disclosed intercom device can be integrated into a sleek device such as embodied in FIGS. 1-5.

The disclosed intercom device can be designed to be a part of a limited network of similar devices. In some embodiments, the limited network may have only two such devices connected with each other. In other embodiments, the limited network may have about three to about ten or so devices interconnected, although the number of devices connected is not limited. The intent of the use of the disclosed device can be to provide a collaboration and camaraderie tool in an attempt to recreate the short, burst communications that typically happen in a workplace, such as an office or other business setting.

The disclosed device and limited network of devices were inspired by “hoot-n-holler” lines that are found on trading floors of, for example, stock exchanges. These open communication lines are used to quickly communicate with a few or multiple people in a time-efficient manner. “Hoot-n-holler” lines have been around for decades and are typically audio-only. They can require very expensive trading turrets and Private Branch Exchange (PBX) equipment and are generally found within the trading world.

The disclosed audio-video intercom device and system of devices differ from “hoot-n-holler” lines in that they can include high fidelity video and audio, do not require proprietary on-premise PBX equipment, are user-managed, and are independent from other telephone systems. Such a device and system are further focused on the current and potential future working environment where a worker is either at home or at an office spaced apart from their colleagues. This has been particularly true in a pandemic world in which people need to be apart from each other, and many workers work from home or a location remote from others. Keeping people and workers connected emotionally in such an isolating environment can be a significant challenge.

The disclosed audio-video intercom device and system of devices can have a minimum of barriers to use. For example, the unit can be placed on a desktop, plugged in, connected by wires, or wirelessly to a network. The disclosed device can differ from existing devices in that it has both audio and video (which typical intercom systems do not have), does not “ring” like a traditional phone, and can hold video conference meetings without any prior setup; no need for invitations and their subsequent acceptance to have a video conference. In some embodiments, the device can require some sort of initial login by the user or could also have automatic biometric login using facial recognition or fingerprint. A user's account can be pre-configured by an admin to have specific contacts available or can be configured by the user to add other available users as contacts. Such a configuration can allow the user to log into any device, anywhere. By pressing one button (activation button), an instant video and audio channel is opened between the user and another user or a collection of users within the system. The disclosed system can be structured and configured for two-way communication of one user with any other user or users on a limited network with activation by an activation button. In some embodiments, the activation button can be “one-click” (activated with one click of a mouse or other computer input devices such as a button or soft key).

In some embodiments, the disclosed audio-video intercom device and system of devices can include a microphone (or array of microphones), a speaker (or multiple speakers), and indicator lights. In some embodiments, the disclosed device and system can also include a focus mode button. The focus mode button can prevent incoming messages from coming through and, instead, can give the caller the ability to leave a video message.

FIG. 1 is a front view of an embodiment of a disclosed audio-video intercom device. Intercom device 100 includes electronic display 102. The electronic display 102 can be any electronic display device but, most typically, can be a liquid crystal (lc) display or a light-emitting diode (led) display device. The electronic display can be identical in most or all aspects to electronic display devices on any desktop, laptop, tablet, or other smart devices. For example, it can be a computer monitor or even a smart tv screen. Typically, for the intended device, the screen can be from about 5 inches (diagonally measured) to about 16 inches (diagonally measured) or even larger, for instance, 20 inches. Typically, the intercom device can fit on a desktop but is not limited to this size.

FIG. 1 shows an embodiment of a disclosed audio-video intercom device 100 that includes console 106. A computer can be embedded within the counsel 106. Console 106 can act as a stand for camera 104 and electronic display 102. Alternatively, console 106 can be separate from monitor 102 and/or camera 104. However, the embodiment shown in FIG. 1 has console 106 and electronic display device 102 as a single unit; there is no need to have a separate monitor in the typical embodiment.

Console 106 can also include some control features. For example, as shown in FIG. 1, console 106 includes volume knob 120, which can be rotated to control volume from the speaker 122 located on device 100. In the embodied example shown in FIG. 1, a wide activation button 110 is shown. This button can be an activation button that immediately activates the audio-video intercom device and allows instant communication of the device with another entity that also has such a device. The activation button can act as a one-click button to put intercom device 100 into active mode. It can also allow for the transmission of an audio and/or video signal to another user. In some embodiments, activation button 110 can transmit a signal only when held down. When released in this embodiment, activation button 110 can cause the transmission to go mute (no audio transmission). In other embodiments, activation button 110 can be pressed once to activate and then pressed again to deactivate and go mute. Other contemplated configurations can include a button to activate or deactivate the camera 104 to prevent a video signal from transmission to another user; this button may be one of the programable buttons 112-116 or a virtual button on the touchscreen. Further embodiments may include a slidable cover for the camera 104 to prevent the transmission of a video image.

Console 106, as shown in FIG. 1, also includes programming buttons (soft buttons) 112, 114, and 116. The disclosed audio-video intercom device is not limited to three programable buttons but may have a plurality of such buttons. Programming buttons 112-116 can be used as “speed dial” buttons to connect intercom device 100 to different devices or a combination of devices in its limited network. For example, button 112 might connect the user of the illustrated device with another user connected to the limited network, say by the name of “Joe” for a private communication. Button 114 might connect the user of the illustrated device with another user connected to the limited network, say by the name of “Alice” for a private communication. And button 116 might instantly connect the user of the disclosed intercom device 100 with both Joe and Alice. Buttons 112-116 or additional buttons can be used or programmed for special communication groups. Such as communication for an entire team of users on the limited access network. For example, one of the programable buttons may instantly connect to a team of ten users.

Intercom device 100 also includes camera 104. In the illustration shown in FIG. 1, the camera is shown in the center above the electronic display device, although this is simply a matter of design choice. Camera 104 can be located anywhere on intercom device 100 that allows a clear view of the user of that device. In some embodiments, camera 104 is pointing toward the speaker. In some embodiments, a camera can be located in the bottom middle of the bezel around the screen. For example, camera 104 can be located on the frame or outer border 103 of electronic display device 102 as is typical of laptop or desktop computers monitors. Alternatively, camera 104 can be mounted on console 106 of intercom device 100. In other embodiments, camera 104 can be a separate (stand-alone or clip-on) device in electronic communication with intercom device 100. For example, an indicator light 118 can be integrated within the border 103 of the electronic display, as illustrated in FIG. 1, wherein the indicator light 118 is disposed within the central lower portion of border 103.

Additionally, the center portion of each of the buttons 112-116, and activation button 110 can include an integrated indicator light, respectively indicator lights 112a, 114a, 116a, and 110a. Other embodiments can have a biometric input device(not shown) to provide user access to the Intercom device 100. Such a biometric feature can be integrated similarly to the indicator light, and it may further be located on the rear side of the console 106.

In the illustrations shown in FIGS. 1, 4, and 5, the console 106 has speaker 122 centrally located on the console 106. Other contemplated embodiments can have a speaker or pair of speakers located on the sides of console 106 or even rearward facing position on the backside of the console. Microphone 108, illustrated in FIG. 1, is located in the lower portion of the border 103 and is an array of three. There may only be one microphone or an array of two microphones in other embodiments.

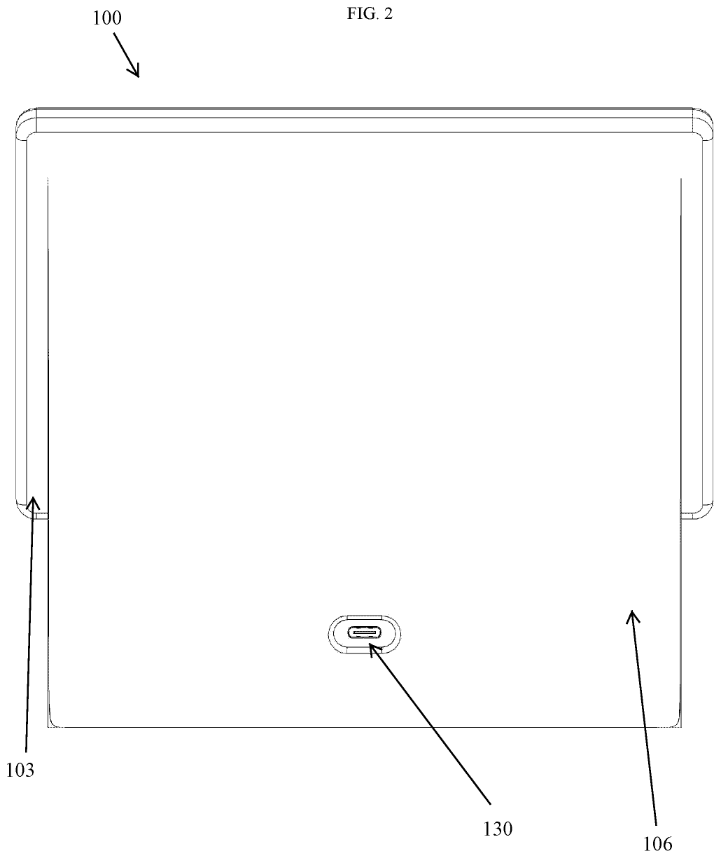

FIG. 2 is a rear view of an embodiment of a disclosed audio-video intercom device 100. Console 106 in the present configuration has port 130. In some embodiments port 130 may be used as a power connection. Other embodiments may include a port 130 that can be used for both power and communication with the limited network. Further embodiments of Console 106 may include multiple ports for other contemplated network connections and power connections. The audio-video intercom device may include any number of wired and wireless connections to provide access to the limited network.

Various modifications and alterations to this disclosure will become apparent to those skilled in the art without departing from the scope and spirit of this disclosure. It should be understood that this disclosure is not intended to be unduly limited by the illustrative embodiments set forth herein and that such embodiments are presented by way of example only with the scope of the disclosure intended to be limited only by the claims set forth herein as follows. All references cited in this disclosure are herein incorporated by reference in their entirety.

What is claimed is:

1. An audio video intercom device comprising:
a console having an embedded computer;
an electronic display attached to and in electronic communication with the console;
at least one camera in electronic communication with the console,
wherein the console comprises one or more control buttons including an activation button.

2. An audio video intercom device according to claim 1, wherein the activation button is a one-click activation button.

3. An audio video intercom device according to claim 2, wherein the activation button is structured and configured to activate the audio video intercom device to broadcast and receive an audio video signal when depressed.

4. An audio video intercom device according to claim 1, further comprising at least one microphone and at least one speaker, and further wherein the console comprises a volume control knob.

5. An audio video intercom device according to claim 1, wherein the one or more control buttons comprises one or a plurality of preset programming buttons.

6. An audio video intercom device according to claim 5, wherein one of the one or more control buttons is programed to connect a plurality of the audio video intercom devices.

7. An audio video intercom device according to claim 1, wherein the electronic display comprises a touchscreen, wherein the electronic display has dimensions of from about 5 inches measured diagonally to about 20 inches measured diagonally.

8. An audio video intercom device according to claim 1, wherein a limited network is in electronic communication with the two or more audio video intercom devices.

9. An audio video intercom device according to claim 1, wherein the one or more control buttons further comprises a focus mode button wherein the focus mode button, when depressed, activates a focus mode which blocks incoming communications.

10. An audio video intercom device according to claim 9, wherein a recorded message may be collected when the focus mode is activated.

11. A system of audio video intercom devices comprising:
two or more audio video intercom devices in electronic communication on a limited network, wherein each audio video intercom device comprises:
a console having an embedded computer;
an electronic display attached to and in electronic communication with the console;
at least one camera, at least one microphone, and at least one speaker attached to and in electronic communication with the console,
wherein the console comprises one or more control buttons including a one-click activation button;
wherein the system is structured and configured for two-way communication of one user with any other user or users on the limited network with activation by the one-click activation button.

12. The system of audio video intercom devices according to claim 11, wherein the electronic display comprises a touchscreen.

13. The system of audio video intercom devices according to claim 11, wherein the one or more control buttons comprises a volume control knob.

14. The system of audio video intercom devices according to claim 11, wherein the one or more control buttons comprises one or a plurality of preset programming buttons.

15. The system of audio video intercom devices according to claim 14, wherein the one or more control buttons further comprises a focus mode button wherein the focus mode button, when depressed, activates a focus mode which blocks incoming communications.

16. A method of communicating using an audio video intercom device comprising:
providing an audio video intercom device,
wherein the audio video intercom device comprises:
a console having an embedded computer;
an electronic display attached to and in electronic communication with the console;
at least one camera, at least one microphone, and at least one speaker attached to and in electronic communication with the console,
wherein the console comprises one or more control buttons including an activation button that allows a user to broadcast at least an audio signal; and
conducting two-way audio video communication with another party using the provided audio video intercom device.

17. The method of communicating using an audio video intercom device according to claim 16, wherein the electronic display comprises a touchscreen.

18. The method of communicating using an audio video intercom device according to claim 16, wherein the one or more control buttons comprises a volume control knob.

19. The method of communicating using an audio video intercom device according to claim 16, wherein the one or more control buttons comprises one or a plurality of preset programming buttons.

20. The system of audio video intercom devices according to claim 19, wherein the one or more control buttons further comprises a focus mode button wherein the focus mode button, when depressed, activates a focus mode which blocks incoming communications.
